(19) United States
(12) Patent Application Publication
(10) Pub. No.: US 2001/0027863 A1
(43) Pub. Date: Oct. 11, 2001

(54) Heat exchanger with safety valve

(75) Inventors: Ludwig Hellenthal, Kirchhundem (DE); Abbott W. Mosher, Gorham, ME (US)

Correspondence Address: FRIEDRICH KUEFFNER, PATENT AND TRADEMARK ATTORNEY, SUITE 1921, 342 MADISON AVENUE, NEW YORK, NY, 10173, US

(73) Assignee: Walzen Irle GmbH and S.D. Warren Service Cmpany

(21) Appl. No.: 09/776,409

(22) Filed: Feb. 2, 2001

(30) Foreign Application Priority Data
Feb. 3, 2000 (DE) 100 04 684.3
Apr. 20, 2000 (DE) 100 19 585.7

(51) Int. Cl. F28F 5/02; F28D 11/02; F28F 27/00; G05D 15/00; G05D 16/00; G05D 23/00

(52) U.S. Cl. 165/281; 165/286; 165/278; 165/89

(57) ABSTRACT

A heat exchanger which is symmetrical with respect to rotation, especially a thermal roller which is driveable for rotation and is heated by a fluid or gas, preferably a heat transfer oil, water or steam, and is preferably used in the paper industry includes at least one shut-off device for cutting off the forward flow and/or return flow of the thermal roller as soon as the forward flow pressure and/or the return flow pressure of the heat transfer medium drops off significantly or drops to zero.

### BACKGROUND OF THE INVENTION

1. Field of the Invention

The present invention relates to a heat exchanger which is usually symmetrical with respect to rotation, particularly a thermal roller which is driveable for rotation, wherein the heat exchanger is heated by a fluid or gas, preferably heat transfer oil, water or steam, and wherein the heat exchanger is preferably used in the paper industry, plastics industry and rubber industry.

2. Description of the Related Art

Because of the very high operating speeds, roller surface temperatures and the attendant fluid input temperatures, the potential dangers continue to increase in the case of leakages. A particularly critical point in the heat transfer chain from the heat producer to the heat exchanger, such as a thermal roller, is the rotary lead-in connection. This lead-in connection facilitates a continuous fluid transport from the stationary pipeline system into the usually rotating heat exchanger. Because of the very high rates of rotation of the heat exchanger, bearing seizures occur at the rotary lead-in connection even if adequate bearing systems and cooling of the bearings are provided. In the best case, the consequences of such a malfunction are that the lead-in connection also rotates, the usually flexible connecting hoses are torn off, and the machine is stopped by a torque monitoring unit.

However, it has frequently happened in the past that the heat transfer medium, particularly heat transfer oil, which emerges after the rupture of the hose is finely distributed within the machine building and is ignited. The heat transfer oil which then continues to emerge from the roller continues to feed the fire, so that the fire is usually very difficult to extinguish.

In order to prevent significant damage, sprinkler systems are installed which extinguish the fire with water or foam. Stop valves in the pipeline systems conducting the heat transfer medium can be automatically closed and prevent further heat transfer medium from emerging. However, such a fire still continues to be fed to some extent because heat transfer oil is still present, for example, in the interior of the heat exchanger and can emerge from the heat exchanger.

### SUMMARY OF THE INVENTION

Therefore, it is the primary object of the present invention to provide a device which prevents additional heat transfer medium from reaching the surroundings of the heat exchanger in the case of an accident.

In accordance with the present invention, at least one shut-off device is provided which shuts off the forward flow and/or the return flow of the heat exchanger as soon as the forward flow pressure and/or the return flow pressure of the heat transfer medium drops significantly or drops to zero.

Accordingly, if there is no flow pressure of the heat transfer medium, the heating lines of the heat exchanger are automatically closed at both ends.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a longitudinal sectional view of an end of the body of a calender roller with a roller neck supporting the roller;

FIG. 2 is a sectional view, on a larger scale, of the roller neck of FIG. 1;

FIG. 3 is a longitudinal sectional view of an end of a roller neck with a two-way rotary lead-in connection mounted on the roller neck; and

FIG. 4 is a sectional view, on a larger scale, of the roller neck of FIG. 3 showing the valves.

### DESCRIPTION OF THE PREFERRED EMBODIMENTS

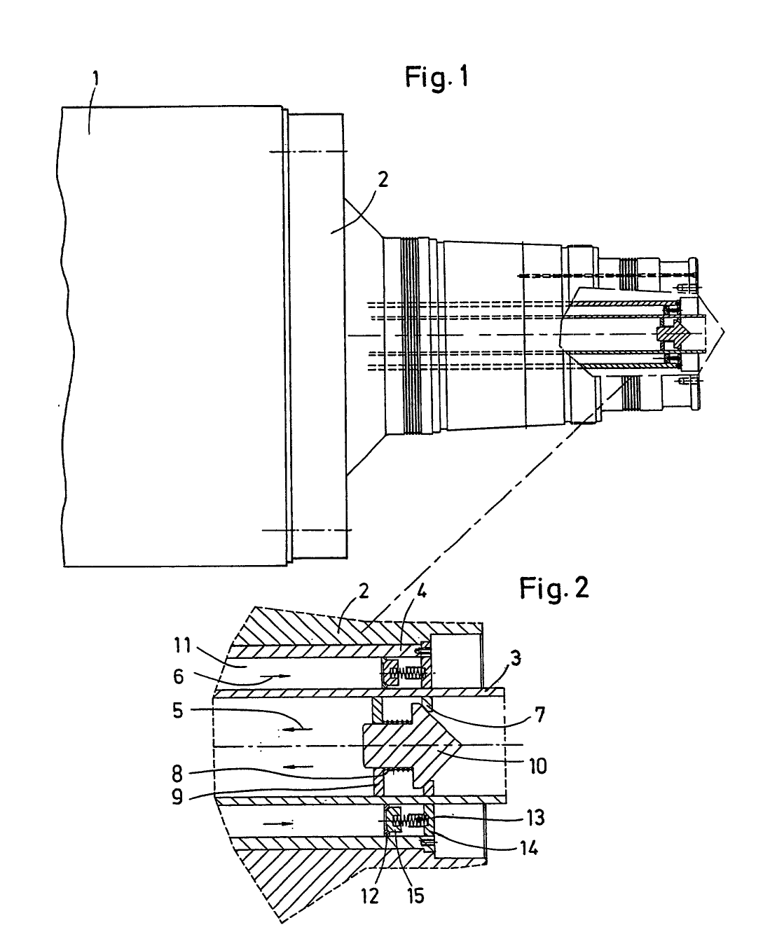

FIG. 1 of the drawing shows an end of a roller body 1 of a heatable calender roller with a roller neck 2 which is mounted on the end surface of the roller by means of screws. A detail of the roller neck 2 shown in FIG. 1 with dash-dot lines is shown in FIG. 2 on a larger scale. An inlet pipe 3 for the heat transfer medium extends axially through the roller neck 2. Spaced from hand surrounding the inlet pipe 3 is an insulating pipe 4 which insulates the roller neck 2 thermally against the heat transfer medium. The heat transfer medium, such as heat transfer oil, is supplied through the inlet pipe 3 in the direction of arrow 5 and leaves the thermal roller in the direction of arrow 6 through the hollow-cylindrical duct 11 formed between the inlet pipe 3 and the insulating pipe 4.

In order to prevent any heat transfer medium from emerging from the roller after the supply lines and/or discharge lines have been torn off, as is the object of the present invention, or also after the rotary lead-in connections have been taken off, the inlet and discharge paths within the roller neck are secured by special stop valves. Thus, a valve seat plate 7 is arranged in the inlet pipe 3, wherein a valve body 10 which is pretensioned by means of a valve body spring 8 and is held by a guide disc 9 is pressed against the valve seat plate 7. The valve body spring 8 is dimensioned in such a way that the heat transfer medium adjacent the valve body 10 can with its conveying pressure push back the valve body 10 and open the check valve formed by the valve body 10, while this check valve is immediately closed and prevents any emergence of the heat transfer medium when the conveying pressure of the heat transfer medium drops off or if a pressure occurs within the calender roller.

The discharge duct 11 formed between the inlet pipe 3 and the insulating pipe 4 is secured in a similar manner. Arranged in this duct 11 is a valve seat ring 12, wherein a ring valve body 15 rests against the valve seat ring 12 by means of sealing ring springs 13 which are supported by a sealing ring spring base 14. This configuration also produces a check valve which is opened by the heat transfer medium which flows out of the interior of the roller in the direction of arrow 6, while this check valve, in the same way as the central check valve, is pretensioned in such a way that the valve is closed when the heat transfer medium flow drops off.

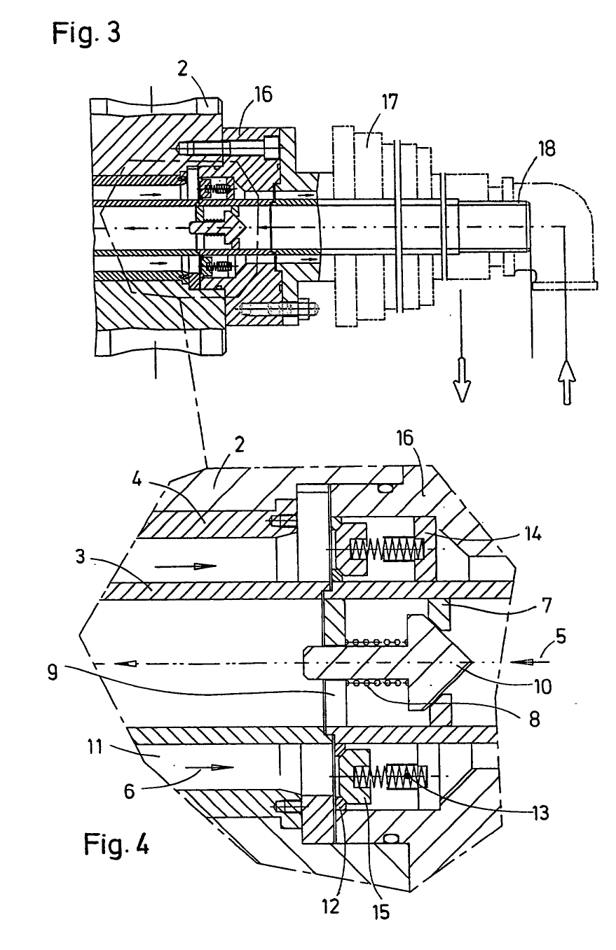

FIG. 3 of the drawing is a partial sectional view of a roller neck 2 on which is mounted an intermediate flange 16 to which, in turn, are connected an outer rotary lead-in connection 17 and an inner rotary lead-in connection 18. The configuration of the valves which close in the case the flow drops off is shown in FIG. 3 and also in FIG. 4 on a larger scale. Also in this case, provided with numerals corresponding to those of FIG. 2, there are two stop valves which automatically close if the flow pressure of the heat transfer medium drops off and lock the heat transfer medium contained in the interior of the roller, so that, in case of emergency as well as when the supply and/or discharge of the heat transfer medium is interrupted due to assembly operations, losses of the heat transfer medium are prevented or at least minimized and, thus, danger due to hot water or the danger of fire due to heat transfer oil are absolutely prevented.

The invention is not limited by the embodiments described above which are presented as examples only but can be modified in various ways within the scope of protection defined by the appended patent claims.

We claim:

1. A heat exchanger which is symmetrical with respect to rotation and is heated by a heat transfer medium, the heat exchanger comprising a thermal roller driveable for rotation having forward flow means and return flow means for the heat transfer medium, and at least one shut-off device for shutting off at least one of the forward flow means and rearward flow means when a forward flow pressure and/or rearward flow pressure of the heat transfer medium drops significantly or drops to zero.

2. The heat exchanger according to claim 1, comprising a valve each in a forward flow duct and rearward flow duct of the heat transfer medium in a roller neck of the thermal roller, such that flow into the thermal roller and return flow from the heat exchanger can be shut off.

3. The heat exchanger according to claim 2, wherein each valve is located fully or partially between the heat exchanger and a rotary lead-in connection for the heat transfer medium.

4. The heat exchanger according to claim 2, wherein the valves are check valves.

5. The heat exchanger according to claim 3, wherein the valves are configured to prevent heat transfer medium from leaking out after the rotary lead-in connection has been disassembled.
